(19) United States
(12) Patent Application Publication
(10) Pub. No.: US 2009/0221449 A1
(43) Pub. Date: Sep. 3, 2009

(54) Presentation of Recognition Motifs by a Multivalent Matrix Grafted Onto a Solid Support

(76) Inventors: Eric Defrancq, Saint-Pierre D'allevard (FR); Pascal Dumy, Allevard (FR); Olivier Renaudet, St. Pierre D'allevard (FR); Francoise Vinet, Grenoble (FR); Antoine Hoang, Grenoble (FR)

Correspondence Address: HARNESS, DICKEY & PIERCE, P.L.C., P.O. BOX 828, BLOOMFIELD HILLS, MI, 48303, US

(21) Appl. No.: 12/224,191

(22) PCT Filed: Feb. 20, 2007
(86) PCT No.: PCT/FR2007/000307

§ 371 Date: Mar. 26, 2009

(30) Foreign Application Priority Data
Feb. 20, 2006 (FR) 0601472

(51) Int. Cl. C40B 40/10; C40B 50/14

(52) U.S. Cl. 506/18; 506/30

(57) ABSTRACT

The invention relates to a method for preparing a grafted homodetic cyclopeptide forming a frame defining two surfaces, one surface being known as the upper surface and the other surface being known as the lower surface, both surfaces being grafted, characterized in the a linear peptide is synthesized, said synthesis is being carried out on modified amino acids or not, some of which include orthogonal protector groups, intramolecular cyclization of the protected linear peptide thus obtained is performed, all or part of the orthogonal protector groups are substituted by a protected precursor, and at least one molecule of therapeutic interest is grafted on one and/or the other surface of the frame by means of an oxime link.

### CROSS-REFERENCE TO RELATED APPLICATIONS

This application is a National Stage of PCT/FR2007/000307, filed Feb. 20, 2007, which claims priority to French Application No. 0601472, filed Feb. 20, 2006, both of which are entirely incorporated herein by reference.

### BACKGROUND AND SUMMARY

The present invention relates to the immobilisation of recognition motifs on solid supports. Immobilisation of molecules on solid supports can notably enable the fabrication of biomolecular chips, notably sugar chips. These can notably be useful in detection, analysis or screening methods.

A large number of methods for immobilising molecules on a solid support are known. They can be classified into two groups:

non-covalent immobilisation methods, which consist of adsorbing molecules on a surface via non-covalent interactions, notably of the hydrophobic, hydrogen bond or ionic bond type. The surface used can notably be glass covered with nitrocellulose or a polystyrene resin.

covalent immobilisation methods, which consist of making a function present on the solid support react with a function present on the molecule in order to form a covalent bond between the molecule and the support.

These methods of immobilising molecules on a solid support can be used to fabricate “recognition motif chips” which can enable the high-speed analysis of molecules involved in the recognition of these recognition motifs, notably sugars. “Sugar chips” enabling the high-speed analysis of proteins can be cited as an example. “Recognition motif chips” obtained by conventional methods can have an insufficient detection level with regard to certain molecules, such as low-affinity proteins. For example, the case of certain sugar chips in relation to lectins can be cited.

There is therefore a requirement for solid supports presenting recognition motifs in which the affinity of these recognition motifs with structures recognising them is improved. The structures recognising the recognition motifs can be parts of molecules or compounds, molecules or compounds, or superstructures comprising these molecules, compounds, or parts of molecules or compounds, notably target molecules or compounds. These superstructures can for example be cells or micro-organisms, such as bacteria or viruses.

Thus the inventors discovered that a solid support on which the recognition motifs are fixed via a specific molecular frame was able to make it possible to improve the detection threshold with certain structures, such as target molecules or compounds. Thus, according to a first aspect, an object of the present invention is a solid support bound to at least one molecular frame making it possible to bind at least one recognition motif in a multivalent manner or presenting at least one recognition motif in a multivalent manner. In the sense of the present invention, “molecular frame” means a molecule capable on the one hand of being bound to a solid support and on the other hand of being bound, notably in a covalent manner, to at least one recognition motif. In the sense of the present invention, “bound in a multivalent manner” means several bonds, each bound to at least one recognition motif. In the sense of the present invention, the molecular frame is “bound in a multivalent manner” means that the molecular frame is bound to several recognition motifs, in particular several times to the same recognition motif, in particular via several bonds.

More particularly, each recognition motif is bound by a bond to the molecular frame. In the sense of the present invention, “recognition motif” means any type of molecule or compound capable of being recognised by, or forming a complex with, at least one other molecule or compound, or part of a molecule or compound. Amongst the compounds, the following can be cited more particularly: receptors, proteins, enzymes and molecules present on or in cells.

In particular, this solid support or chip has an excellent detection threshold, in particular for compounds or entities having an affinity with the recognition motifs, more particularly in relation to the compounds or entities which can or are to be detected by said support or chip. This detection threshold can be less than or equal to 1 mM, in particular less than or equal to 0.5 mM, notably less than or equal to 0.2 mM, more particularly less than or equal to 0.1 mM, perhaps indeed less than or equal to 0.08 mM, or even less than or equal to 0.05 mM, perhaps indeed even more particularly less than or equal to 0.01 mM. This detection threshold can also be less than or equal to 1000 microg/ml, in particular less than or equal to 500 microg/ml, notably less than or equal to 200 microg/ml, more particularly less than or equal to 100 microg/ml, perhaps indeed less than or equal to 50 microg/ml, or even less than or equal to 20 microg/ml, perhaps indeed even more particularly less than or equal to 10 microg/ml, by weight of compound or entity to be detected with respect to the composition volume, as a solution or a suspension, in which it is present.

### BRIEF DESCRIPTION OF THE DRAWINGS

FIG. 1 depicts schematically the plate obtained in Example 1.

FIG. 2 is the picture of direct labelling by FITC-lectin specific for lactose obtained in Example 2.

FIG. 3 is the picture of direct labelling by FITC-lectin specific for N-acetylgalactose.

FIG. 4 depicts schematically the plate obtained in Example 4.

FIG. 5 is the picture of the plate obtained in Example 4 after labelling by FITC-lectin specific for N-acetylgalactose using the scanner.

FIG. 6 depicts the functionalisation of a glass plate by a molecular frame, oxidation, depositing of ligands (respectively N-acetylgalactose and mannose), and then visualisation by labelling.

### DETAILED DESCRIPTION

The molecular frame can have several bonds with recognition motifs; it can in particular be bound several times with several identical recognition motifs, or with several different recognition motifs. A molecular frame bound in a multivalent manner to at least one recognition motif can be depicted as follows:

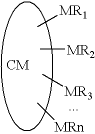

where CM represents a molecular frame, and MR₁, MR₂, MR₃, . . . , MRₙ each represent an identical or different recognition motif, n representing an integer number greater than 1, notably greater than or equal to 2, in particular greater than or equal to 3, perhaps indeed greater than or equal to 4, and notably less than or equal to 32, in particular less than or equal to 24, more particularly less than or equal to 16, perhaps indeed less than or equal to 8.

Multivalent grafting can also be defined by the ratio of number of links or bonds between the molecular frame and recognition motifs/number of links or bonds between the molecular frame and the solid support. In this case, this is greater than 1, notably greater than or equal to 2, in particular greater than or equal to 3, perhaps indeed greater than or equal to 4.

According to a particular embodiment, the molecular frame has at least two faces, in particular it has two faces. More particularly, this molecular frame can be a cyclopeptide, notably defining two faces, an upper face and a lower face. The molecular frame can present several recognition motifs grafted onto its upper face, notably several times the same motif or different recognition motifs each grafted one or more times. The solid support is bound to the molecular frame, notably by the lower face thereof, in particular by at least one covalent bond, more particularly by an oxime bond. Amongst the molecular frames capable of being used in the present invention, those described in the application WO 2004/026894 can be cited.

The molecular frame can be a cyclopeptide formed from 5, 10 or 14 amino acid residues, notably from 10 amino acids forming a cyclodecapeptide. This cyclopeptide can have at least one bend, notably two bends notably for forming the chain (L)Pro-(D)AA or (D)Pro-(L)AA. This cyclopeptide can also have a central symmetry. The cyclopeptide can have 10 or 14 amino acid residues and form two bends, each bend being formed by a combination (L)Pro-(D)AA or (D)Pro-(L)AA, AA being an amino acid and preferably glycine, the two bends being separated by three and/or five amino acid residues.

The amino acid residue of the bend represented above by the initials AA can be an amino acid residue other than proline and of opposite stereochemistry; it can in particular be glycine residue. The bends are separated by amino acid residues, notably by an odd number of amino acid residues and in particular by three and/or five amino acids for a cyclodecapeptide and a cyclotetradecapeptide respectively. The three and/or five amino acid residues can each have a chemical function protected orthogonally by a protective group. The protective groups of the side chains of these amino acids run alternately either side of the median plane of said frame and define a so-called lower and upper face with respect to this plane.

In particular, the molecular frame is a cyclodecapeptide with the following formula (I):

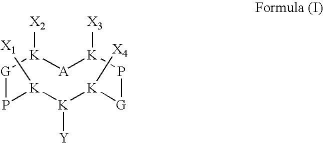

in which Y represents a chemical entity forming a bond with a solid support and X₁, X₂, X₃ and X₄ each represent independently of one another a chemical entity, protected, or masked, or not, making it possible to bind, or binding, at least one recognition motif.

“Protected chemical entity” means a chemical entity carrying a protective group. These groups are known conventionally by persons skilled in the art and described in reference works, notably “Protective Groups in Organic Synthesis” by T. W. Green, P. G. M. Wuts, Wiley-Interscience, New York, 1999. “Masked chemical entity” means a chemical entity carrying a group or residue making it possible to conceal said chemical entity. Such a residue can be an amino acid residue, for example a serine residue. More particularly, X₁, X₂, X₃, X₄ and Y can represent entities carrying at least one function chosen from the group comprising the amine, hydroxyl, thiol and hydrazide functions and in particular aldehyde and oxyamine.

The solid support can notably be in the form of plates, notably well plates, beads, notably porous, notably microbeads, channels, notably capillaries or chambers, such as closed cavities constituting micro-components with micro-structured surfaces, or nanostructures, notably carbon nanotubes. The solid support can notably comprise, or be composed of, at least one material chosen from the group comprising glass, silicon, semiconductor oxides, for example silicon oxide, plastic, gold, metal oxides, notably such as indium oxide and tin oxide, sol-gels, rare earths, and organic (carbon-based) assemblages, such as carbon nanotubes. The solid support can be bound directly or indirectly to the molecular frame. “Bound indirectly” means that a spacer is bound to each of the entities cited or else that the bond is made via at least one spacer.

A spacer can be any type of molecule capable of binding with the entities to which it is to be attached. In particular it can be molecules separating the two entities by 1 to 20 atoms, notably by 2 to 15 atoms, in particular by 4 to 10 atoms. More particularly the spacer has a carbonaceous backbone, possibly comprising at least one heteroatom, for example oxygen, sulphur, nitrogen or phosphorus.

The molecular frame is bound to the solid support by at least one bond, notably a covalent bond; this can be chosen from the group comprising ether, ester, amine, amide, thioether, oxime, phosphate, alkene, alkyne, hydrazide and disulphide bonds. According to a particular embodiment, the solid support is bound to the molecular frame via an oxime bond.

The recognition motifs can be of different types; amongst the recognition motifs usable according to the invention, the molecules of interest, in particular of biological interest, can be cited. Amongst the recognition motifs, the following can be cited: molecules chosen from the group comprising sugars, and in particular mono- or oligosaccharides, nucleic acids, peptides, proteins, as well as “mixed” molecules, such as glycopeptides, glycoproteins or phospholipids, or organic molecules, in particular those having a therapeutic or diagnostic interest, and a mixture thereof. Amongst the monosaccharides, and in particular those comprising or comprised in oligosaccharides, the following can be cited: glucose, fructose, galactose, mannose, rhamnose, fucose, glucosamine, galactosamine, mannosamine, N-acetylglucosamine, N-acetylgalactosamine, N-acetylmannosamine, glucuronic acid, galacturonic acid, mannuronic acid, N-acetylneuraminic acid and 3-deoxy-D-manno-2-octulosonic acid.

The recognition motifs can be bound to the molecular frame directly or indirectly. The recognition motifs can be bound to the molecular frame by at least one covalent bond; this can be chosen from amongst ether, ester, amine, amide, thioether, oxime, phosphate, alkene, alkyne, hydrazide and disulphide bonds. According to a particular embodiment, the recognition motifs are bound to the molecular frame via an oxime bond.

According to another of its aspects, another object of the invention is a method of fabricating a solid support comprising at least one molecular frame making it possible to present, or presenting, at least one recognition motif in a multivalent manner, comprising at least the step consisting of grafting onto the solid support at least one molecular frame making it possible to present, or presenting, at least one recognition motif in a multivalent manner on a support. In the sense of the present invention, “grafted” means that a bond, notably of covalent type, is formed between two chemical entities.

According to a first embodiment, the complexes comprising molecular frame/recognition motifs are grafted onto the solid support. This strategy consists of synthesising and purifying individually the complexes comprising molecular frame/recognition motifs, in particular molecular frame/sugars, and then of grafting them onto the solid support.

Recognition motifs can be grafted onto the molecular frame by a chemical bond resulting from the condensing of a function carried by the molecular frame and a function carried by the recognition motif. Amongst the bonds making it possible to graft recognition motifs onto the molecular frames, the following can be cited: amide, ester, ether, amine, oxime, phosphate, alkene, alkyne, hydrazide and disulphide bonds. According to a variant, the molecular frame comprises at least one aldehyde or oxyamine bond capable of reacting with at least one function present on the solid support, in particular to form an oxime bond.

Recognition motifs can be grafted onto the molecular frame, notably when the latter comprises amino acid residues, using the chemistry of oxyamines, in particular in the case where the recognition motifs are sugars. In this case, the molecular frame can carry a carbonyl-containing derivative group (aldehyde or ketone) and the sugar can be modified in terms of anomeric position by an oxyamine (—ONH₂) function, or vice versa the sugar can carry a carbonyl-containing function, notably on its reducing end, and the molecular frame can carry an oxyamine (—ONH₂) function. More particularly, at least one reactive function carried by the molecular frame is protected or masked, notably by a serine residue.

In the case where the reactive functions, that is to say those intended to react with the recognition motifs, are protected or masked, it is necessary to carry out a step of protection removal or regeneration in order to liberate the reactive functions. For example, when the upper face of the molecular frame carries one or more serines, these can be oxidised, notably by sodium periodate, so as to obtain glyoxylic aldehyde (—CO—CHO) functions.

At the end of the protection removal step, it is then possible to graft the recognition motifs onto the molecular frames. The recognition motifs can in particular be sugars carrying an oxyamine function capable of reacting with the aldehyde functions of the molecular frames to form oxime bonds. According to a variant, the recognition motifs can be grafted onto the molecular frame via a spacer. Amongst the types of grafting possible, the reaction of an aldehyde function present on the solid support with an oxyamine function present on the lower face of the molecular frame can be cited. In general, this reaction is efficient and selective, and leads to the formation of an oxime bond. Thus, more particularly, the solid support is bound to the molecular frame via an oxime bond. The step of grafting the molecular frame carrying the recognition motifs onto the solid support can be carried out by depositing drops of solution comprising the molecular frame/recognition motif molecules, either manually, which gives a spot diameter of approximately 1 mM, or using a programmable controller, which makes it possible to reduce the size of the spot, for example to 180 μm.

According to another embodiment, the molecular frame is grafted onto the solid support, and then the recognition motifs are next grafted onto the molecular frame. This method of fabricating a solid support enabling a multivalent presentation of recognition motifs can comprise at least the following steps consisting of:

grafting the molecular frame onto the solid support;

grafting the recognition motifs to the molecular frame.

This method can also comprise at least one of the following steps consisting of:

masking and/or protecting the reactive functions of the solid support that have not reacted with the molecular frame and are capable of interfering with subsequent steps; and

removing protection from the reactive functions of the molecular frame which are intended to react with the recognition motifs.

This embodiment is particularly advantageous since it can enable production of a support presenting a great variety of recognition motifs using a single molecular frame. In this case, the functions intended to react with the recognition motifs, for example those present on the upper face of the molecular frame, do not react with the functions present on the solid support, either by their very nature, or because they are protected or masked.

Immobilisation of the molecular frame on the solid support can be done by the reaction of a function carried by the solid support with at least one function carried by the molecular frame, in particular situated on the lower face of the molecular frame. More particularly, the function carried by the solid support is an aldehyde function, and the function carried by the molecular frame is an oxyamine, which leads to the formation of an oxime bond.

This grafting step can be done by depositing a solution comprising the molecular frame on the solid support. The deposition can take place over the entire surface of this support or only at certain locations. This step of grafting the molecular frame can be followed by a step which makes it possible to mask the reactive functions of the solid support that have not reacted with the molecular frame, for example by putting the solid support into contact with a hydroxylamine solution in order to mask the aldehyde functions that have not reacted. According to a variant, at least one recognition motif is grafted onto the molecular frame by reaction with at least one reactive function of said molecular frame.

The method according to the invention can also comprise a saturation step which can consist of absorbing a protein not specifically recognising the recognition motif, such as for example bovine serum albumin (BSA). This step can notably make it possible to avoid the non-specific absorption of proteins, or targets, on the surface during the step of recognition of the recognition motif, for example by the protein to be detected. This saturation step can make it possible to reduce the background noise. According to another of its aspects, yet another object of the invention is a chip comprising at least one solid support as defined above or obtained by a method as defined above.

It can in particular be a sugar chip which has a major importance notably in the high-speed analysis of proteins involved in the recognition of sugars. Amongst the residues capable of acting as a recognition motif, the following can be cited: the osidic residues involved in many pathologies, such as cancer (presence of sugar-based tumoral markers), AIDS, or else resulting from attacks by pathogenic and bacterial agents, the pathogenic or bacterial agents possibly presenting at their surfaces recognition motifs, such as receptors, with saccharidic motifs. Searching for antigens, bacteria and viruses in biological fluids using these chips can also be envisaged. The invention can also be used within the context of detection of pathogenic agents in water or air.

The invention can also be usable in the discovery of medicines, through the recognition of antagonists or agonists of cell receptors based on the recognition of sugars within the context of high-speed screening. The invention can also be used for studying the specificity and affinity of natural but also synthetic sugars. The typing of cells and/or proteins involved in recognition within the organism and correlation with the structure of the sugar can also be envisaged. The present invention also relates to the use of molecular frames making it possible to bind at least one recognition motif in a multivalent manner or presenting at least one recognition motif in a multivalent manner in order to functionalise a surface, in particular with sugars.

The following examples are given by way of illustration and can under no circumstances lead to limiting the invention.

### EXAMPLES

### Example 1

### Preparation of a Chip Allowing Detection of Lectin

The following are prepared:

an aqueous solution (A) comprising 30 μM of compound (A) with the following formula (II)

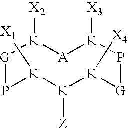

### Formula (II)

in which X₁, X₂, X₃ and X₄ each represent —NHCOCH═NOR, R represents a lactose and Z represents —NHCOCH₂ONH₂;

an aqueous solution (B) comprising 30 μM of R—ONH₂, R represents a lactose;

an aqueous solution (C) comprising 30 μM of a compound (C) with formula (II) above in which X₁, X₂, X₃ and X₄ each represent —NHCOCH═NOR, R represents a —N-acetylgalactose, and Z represents —NHCOCH₂ONH₂; and

an aqueous solution (D) comprising 30 μM of R—ONH₂, R represents an N-acetylgalactose.

A drop of each of these compositions is deposited manually or by means of a robot (for example equipped with piezoelectric pipettes such as the Packard Instrument BioChip Arrayer 1) on part of a glass plate functionalised by an aldehyde, for example fabricated according to a method described in the document EN 0016940.

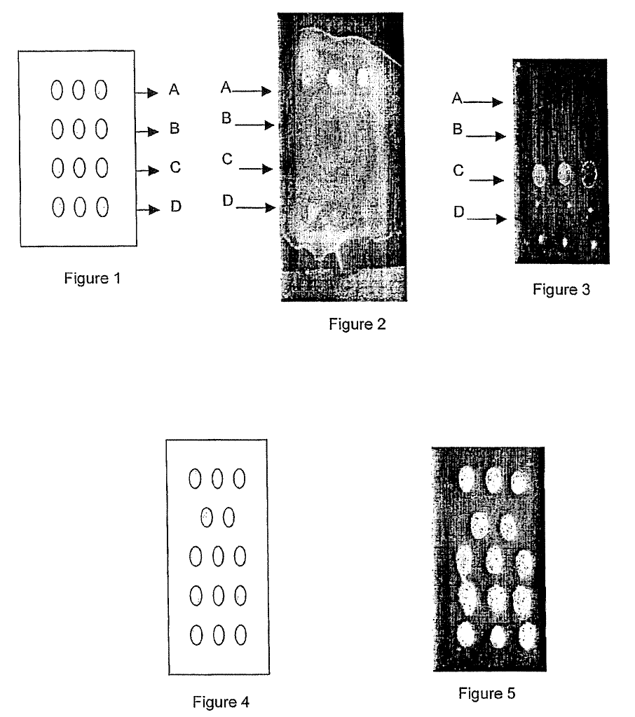

The plate obtained is depicted schematically in FIG. 1:

the line A represents the spots obtained with the solution (A);

the line B represents the spots obtained with the solution (B);

the line C represents the spots obtained with the solution (C);

the line D represents the spots obtained with the solution (D).

### Example 2

### Detection of FITC-Lectin Specific for Lactose by a Chip from Example 1

Next, direct labelling of a chip from Example 1 is carried out with FITC-lectin specific for lactose. Specific detection of said lectin by the part of the chip presenting the lactose recognition motif in a multivalent, in this case tetravalent, manner is then observed. The result is shown in FIG. 2. It can be seen in FIG. 2 that only the spots obtained with the molecular frames carrying four lactose motifs detect the FITC-lectins specific for lactose at 30 μM.

### Example 3

### Detection of FITC-Lectin Specific for N-Acetylgalactose by a Chip from Example 1

Direct labelling of a chip from Example 1 is carried out with FITC-lectin specific for N-acetylgalactose. Specific detection of said lectin by the part of the plate presenting the N-acetylgalactose recognition motif in a multivalent, in this case tetravalent, manner is then observed. The result is shown in FIG. 3. It can be seen in FIG. 3 that only the spots obtained with the molecular frames carrying four N-acetylgalactose motifs detect the FITC-lectins specific for N-acetylgalactose at 30 μM.

### Example 4

### Preparation of a Solid Support onto which there is Grafted a Molecular Frame and then Recognition Motifs

An aqueous solution (E) is prepared, comprising 50 μM of a molecular frame (E) matching the formula (II) in which X₁, X₂, X₃ and X₄ each represent a serine residue, and Z represents —NHCOCH₂ONH₂. A glass plate carrying aldehyde groups is functionalised by soaking it in the molecular frame solution (E).

Next, a so-called saturation step is carried out, consisting of making the aldehydic functions of the glass plate that have not reacted with hydroxylamine react, by soaking said plate in a 10 mM hydroxylamine solution.

Next, oxidation of the serines into aldehydes is carried out by soaking the plate in a 10 mM sodium periodate solution for 60 minutes. Next, a drop of a solution of N-acetylgalactose carrying an —O—NH₂ function is deposited on the anomeric carbon. Then a step of saturation with a solution of Bovine Serum Albumin (BSA) is carried out. The plate obtained is depicted schematically in FIG. 4.

Finally, visualisation is carried out by labelling with FITC-lectin specific for N-acetylgalactose, and passage with a scanner. The result is shown in FIG. 5. It can be seen in FIG. 5 that the spots obtained with the molecular frames carrying four N-acetylgalactose motifs obtained as described above allow detection of the FITC-lectins specific for N-acetylgalactose at 30 μM.

### Example 5

### Preparation of a Solid Support onto which there is Grafted a Molecular Frame and then Recognition Motifs

An aqueous solution (E) is prepared, comprising 50 μM of a molecular frame (E) matching the formula (II) in which X₁, X₂, X₃ and X₄ each represent a serine residue, and Z represents —NHCOCH₂ONH₂. A glass plate carrying aldehyde groups is functionalised by soaking it in the molecular frame solution (E) for 30 minutes.

Next, a so-called saturation step is carried out, consisting of making the aldehydic functions of the glass plate that have not reacted with hydroxylamine react, by soaking said plate in a 10 mM hydroxylamine solution. Next, oxidation of the serines into aldehydes is carried out by soaking the plate in a 10 mM sodium periodate solution for 60 minutes. Next, a drop is deposited of a 50 μM solution of N-acetylgalactose or mannose carrying an —O—NH₂ function on the anomeric carbon. This is left to incubate for 30 minutes and washed with water, then 0.2% SDS and then again with water.

Then a step of saturation with a solution of Bovine Serum Albumin (BSA) is carried out. Finally, visualisation is carried out by indirect labelling: the plate is soaked in a solution of lectin specific for N-acetylgalactose or mannose (concentration 10 μg/mL), with visualisation using streptavidin Cy3, and passage with a scanner. The result is shown in FIG. 1.

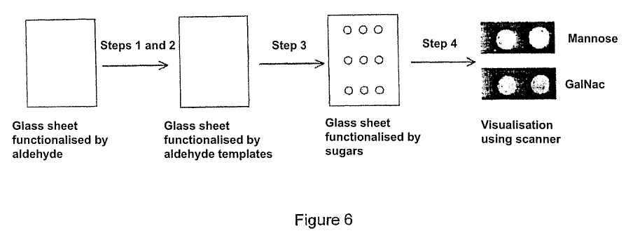

It can be seen in FIG. 6 that the spots obtained with the molecular frames carrying four N-acetylgalactose motifs obtained as described above allow detection of the corresponding lectins specific for N-acetylgalactose and that the molecular frames carrying four mannose motifs obtained as described above allow detection of the corresponding lectins specific for mannose at 50 μM. Furthermore, good selectivity of the recognition is observed: this is because, with the molecular frames carrying four N-acetylgalactose motifs obtained as described above, there is no signal with corresponding lectins specific for mannose and with the molecular frames carrying four mannose motifs obtained as described above, there is no signal with corresponding lectins specific for N-acetylgalactose.

More precisely, FIG. 6 depicts:

Step 1: Functionalisation of the glass plate by the molecular frame (E) and then saturation by NH₂OH;

Step 2: Oxidation of the serine residues into aldehyde;

Step 3: Deposition of drops of a 50 μM solution of N-acetylgalactose (line 1) or mannose (line 2) carrying an —O—NH₂ function;

Step 4: Visualisation by indirect labelling, Line 1 biotinylated lectin specific for N-acetylgalactose then streptavidin Cy3 and line 2 biotinylated lectin specific for mannose then streptavidin Cy3 (concentration 10 μg/ml).

1. A solid support bound to at least one molecular frame making it possible to bind at least one recognition motif in a multivalent manner or presenting at least one recognition motif in a multivalent manner.

2. A solid support according to claim 1, wherein the molecular frame has at least two faces, and notably two faces.

3. A solid support according to claim 1, wherein the molecular frame is a cyclopeptide, notably defining two faces.

4. A solid support according to claim 1, wherein the molecular frame is a cyclopeptide having at least one bend, notably having two bends, notably formed by the chain (L)Pro-(D)AA or (D)Pro-(L)AA.

5. A solid support according to claim 1, wherein the molecular frame is a cyclopeptide comprising 10 or 14 amino acid residues.

6. A solid support according to claim 1, wherein the molecular frame is a cyclopeptide with the following formula (I): 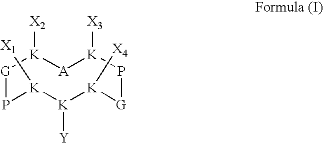
in which Y represents a chemical entity forming a bond with a solid support and X₁, X₂, X₃ and X₄ each represent independently of one another a chemical entity, protected, masked, or not, making it possible to bind, or binding, at least one recognition motif.

7. A solid support according to claim 1, wherein the molecular frame presents several recognition motifs grafted onto its upper face, notably several times the same motif.

8. A solid support according to claim 1, wherein the molecular frame is bound to the solid support by at least one covalent bond, for example of the type of an ether, ester, amine, amide, thioether, oxime, phosphate, sulphate, alkene, alkyne, hydrazide and disulphide bond, and in particular an oxime bond.

9. A solid support according to claim 1, wherein the molecular frame is bound indirectly to the solid support, notably via at least one spacer.

10. A solid support according to claim 1, wherein the support is in the form of plates, notably well plates, beads, notably microbeads, channels, notably capillaries or chambers, or nanostructures, notably carbon nanotubes.

11. A solid support according to claim 1, wherein the support comprises glass, silicon, semiconductor oxides, for example silicon oxide, plastic, gold, metal oxides, notably such as indium oxide and tin oxide, sol-gels, rare earths, or organic assemblages such as carbon nanotubes.

12. A solid support according to claim 1, wherein the recognition motif is a molecule of interest, in particular of biological interest, notably chosen from the group comprising sugars, nucleic acids, peptides, proteins, “mixed” molecules, notably glycopeptides, glycoproteins, phospholipids, and a mixture thereof.

13. A solid support according to claim 1, wherein the recognition motif is bound to the molecular frame by at least one covalent bond, notably an ether, ester, amine, amide, thioether, oxime, phosphate, alkene, alkyne, hydrazide or disulphide bond, and in particular an oxime bond.

14. A solid support according to claim 1, wherein the recognition motif is bound indirectly to the molecular frame.

15. A method of fabricating a solid support comprising at least one molecular frame making it possible to present, or presenting, at least one recognition motif in a multivalent manner, comprising at least the step consisting of grafting at least one molecular frame making it possible to present, or presenting, recognition motifs in a multivalent manner on a solid support.

16. A method according to claim 15, wherein the solid support comprises at least one aldehyde function or an oxyamine bond.

17. A method according to claim 15, wherein the molecular frame comprises at least one aldehyde or oxyamine bond capable of reacting with at least one function present on the solid support.

18. A method according to claim 15, wherein the solid support is bound to the molecular frame via an oxime bond.

19. A method according to any claim 15, further comprising at least one reactive function carried by the molecular frame is protected or masked, notably by a serine residue.

20. A method according to claim 19, further comprising at least one reactive function carried by the molecular frame has its protection removed or is regenerated, and in particular at least one serine residue is oxidised into glyoxylic aldehyde.

21. A method according to claim 15, further comprising at least one recognition motif is grafted onto the molecular frame by reaction with at least one reactive function of said molecular frame.

22. A method according to claim 15, wherein the recognition motif is chosen amongst a molecule of interest, in particular of biological interest, notably a sugar, nucleic acid, peptide, protein, another organic molecule or a mixture thereof, notably a glycopeptide, glycoprotein or phospholipid.

23. A method according to claim 15, wherein the recognition motif carries at least one oxyamine or aldehyde function reacting with at least one aldehyde or oxyamine function, and in particular with a glyoxylic aldehyde group, carried by the molecular frame, to form an oxime bond.

24. A chip, notably a sugar chip, comprising at least one solid support as defined according to claim 1.

25. A use of molecular frames making it possible to bind at least one recognition motif in at least one of: (a) a multivalent manner; and (b) presenting at least one recognition motif in a multivalent manner; in order to functionalise a surface.
